(19) United States
(12) Patent Application Publication
(10) Pub. No.: US 2013/0285555 A1
(43) Pub. Date: Oct. 31, 2013

(54) Automated Reporting System for Obstruction Lighting Outages

(71) Applicants: Ronald P. Kumetz, JR., Alburgh, VT (US); Robert C. Tarsio, Cortlandt Manor, NY (US)

(72) Inventors: Ronald P. Kumetz, JR., Alburgh, VT (US); Robert C. Tarsio, Cortlandt Manor, NY (US)

(21) Appl. No.: 13/874,478

(22) Filed: Apr. 30, 2013

Related U.S. Application Data
(60) Provisional application No. 61/640,717, filed on Apr. 30, 2012.

(51) Int. Cl. H05B 37/03

(52) U.S. Cl. CPC H05B 37/03
USPC 315/129

(57) ABSTRACT

The present invention is a device which automatically reports an obstruction lighting outage creating or canceling a Notice to Airmen (NOTAM) without the need for human intervention. This system greatly reduces the time between detection of a lighting outage and notification of aviation authorities, thus minimizing hazards to air traffic. In addition, this device will create a new NOTAM and cancel the original NOTAM just prior to the original NOTAM expiring if the problem has not been fixed before the original NOTAM expires.

### BACKGOUND OF THE INVENTION

The present invention relates to the field of obstruction lighting for tall structures, and specifically to a system for automatically reporting outages of obstruction lighting systems.

For any tall manmade structure, such as communication towers, water towers, and buildings, regulatory agencies typically mandate requirements for including obstruction lighting. The obstruction lighting may be some combination of persistent or flashing red lights or high intensity white lights. These obstruction lights serve as a means to warn air traffic of the presence of the structure to avoid collision.

When obstruction lights fail, a dangerous situation exists until the lights are put back in service. In most cases, such as in the United States, the owner of the structures are required to give notice of lighting failures within a certain time period of failure so that airmen can be warned of the failure when transiting in the area of the structure. The Notice to Airmen (NOTAM) Management System is overseen by the Federal Aviation Administration (FAA) in the United States. If the NOTAM is not properly registered, not only does it create a serious hazard, but the owner of the structure is also subject to penalties and fines.

The NOTAM reporting requirement creates a burden on the tower owner to have a process in place for detecting the failed obstruction lighting, make contact with the relevant regulatory agency to report the failure, correct the failed lighting, then make contact with the regulatory agency again to cancel the notice of outage.

A number of typical devices exist for monitoring obstruction lighting and creating notifications of outages to the tower owners or designees, but none provides a means of automatically creating the NOTAM in the regulatory management system.

Some typical obstruction lighting monitoring devices are described by the following U.S. Patents.

U.S. Pat. No. 7,196,633 relates to a mechanism for controlling and monitoring radio tower lights. This device is a good example of what is currently available in terms of detecting an error condition in obstruction lighting. This device does not automatically create a notice of failure to regulatory agencies.

U.S. Pat. No. 6,396,216 relates to an apparatus for detecting lamp faults and provides a signaling device as an indicator when a fault is detected.

These and other prior art devices related to lamp fault detection or obstruction lighting control and error detection disclose only the error detection aspect but do not disclose the functionality to automatically create notices to regulatory agencies nor the ability to keep track of the status of these notices after the initial reporting. Someone still has to monitor the alarm status of these system and then manually create the notice, such as a NOTAM, to the regulatory agency. The need for manual entry increased the chances for failure either by the NOTAM not being created within the required time period or by the NOTAM itself containing errors do to the manual entry.

It can be appreciated that there is need for a device to automatically manage reporting to regulatory agencies and to monitor the status of the notices until final disposition of the reported lighting outage.

### BRIEF SUMMARY OF THE INVENTION

The present invention is designed to automatically detect and report lighting outages when they occur and to cancel the notice of outage upon correction of the failed condition. The present invention is a device which automatically reports an obstruction lighting outage creating or canceling a Notice to Airmen (NOTAM) without the need for human intervention. This system greatly reduces the time between detection of a lighting outage and notification of aviation authorities, thus minimizing hazards to air traffic. In addition, this device will create a new NOTAM and cancel the original NOTAM just prior to the original NOTAM expiring if the problem has not been fixed before the original NOTAM expires.

One benefit of the automation provided by the present invention is that the possibility of human error is minimized. All relevant information for the obstruction lighting system being monitored can be entered and stored for use by the automation device. An example of typical human errors that have been experienced include creating a NOTAM for the wrong city, such as a NOTAM created for Burlington, Iowa, when the outage had actually occurred in Burlington, Vt.

The present invention is a device comprising one or more inputs that connect to obstruction lighting control and monitoring devices which will provide stimuli to indicate that one or more obstruction lights are not functioning properly.

The present invention is a device that has one or more inputs and/or a switch to allow manual input of an obstruction lighting failure causing the creation of a Notice to Airmen (NOTAM) and optionally other notifications and warnings. These may include but are not limited to email, relay closures, warning lights, local or remote displays and sound generating devices.

The present invention is a device that has one or more inputs to sense ambient light for the purpose of determining if obstruction lighting should be enabled in night-only lighting applications.

The present invention is a device that has one or more inputs to provide feedback directly from the light source. This may include but is not limited to current sensors or light detectors.

Additionally, the device may include one or more inputs to monitor A/C power and a generator for the purpose of determining whether or not the lighting system has a power source. Detection of a power outage to the lighting system provides an indirect indication of lighting failure in order to generate the NOTAM.

The device may include one or more inputs used to acknowledge an outage and to cause the cancelation of a previously generated NOTAM as well as other notifications and warnings as previously described, that may include but are not limited to email, relay closures, warning lights, local or remote displays and sound generating devices.

The device may include one or more display devices to indicate the status of the device as well as attached lighting monitoring or control devices. In addition, the device may include one or more relay closure outputs to signal the status of the device to other devices or systems.

The device may include communication ports allowing for Ethernet communications for the purpose of (but not limited to) electronic mail (EMAIL), device setup via a web browser interface, alerting capabilities, communications with other devices and electronic communications with the federal NOTAM management system. The device may also include serial communication for the purpose of (but not limited to) communications with external devices or modem communications.

A number of features may be included in the NOTAM Manager device to maintain system integrity and complete management of NOTAMs for an Antenna Structure Registration/Aviation Safety Network (ASR/ASN).

The system integrity is maintained through several features, including the following:
Periodic test of connection with FCC Numbering System (FNS) with notification of loss of communications (LOC) and logging of LOC.
Periodic status email to test email system & provide confidence indication as well as status of lighting system
Provision for redundant email servers.
Periodic test of LAN/WAN connectivity and automatic switchover to backup communications.
Provision for redundant connectivity paths including but not limited to: Ethernet (Wired or Wireless), Telephone (POTS, Fiber, DSL), Cable Modem, Cellular/Public Wireless System, Private Radio System, and Dry Closure Connection to other system(s).
Intelligent system integrity failover—e.g.: If there is a loss of communications with FNS system is there a LAN connection? If not, switch to alternative communications before attempting to make email notification.
Battery backup power supply with notification when running on battery power and notification when battery level is low.
Operation with optional redundant power supply/battery backup

The device also includes NOTAM management features such as:
Generate NOTAM upon qualification of obstruction lighting failure including sustained power outage to lighting system
Monitor NOTAM to prevent NOTAM from being cancelled before obstruction lighting failure is addressed
Monitor ASR/ASN to alert owner of creation of erroneous NOTAM by other entities (e.g.: accidental creation of NOTAM by using incorrect ASR or ASN)
Manage temporary NOTAM during maintenance of lighting system

The device may include a power supply with optional battery backup.

One implementation of the device includes the use of a microprocessor which will be programmed to manage the operation and functionality of the device, such as input/output sensing, control, messaging and communications.

The device may include one or more memory devices for the purpose of holding non-volatile device configuration settings.

In order that the detailed description of the invention may be better understood and that the present contribution to the art can be more fully appreciated, additional features of the invention will be described hereinafter. It should be appreciated by those skilled in the art that the conception and the disclosed specific methods and structures may be readily utilized as a basis for modifying or designing other structures for carrying out the same purposes of the present invention. It should be realized by those skilled in the art that such equivalent methods and structures do not depart from the spirit and scope of the invention.

For a better understanding of the invention and its operating advantages, reference should be made to the accompanying drawings and descriptive matter in which there are illustrated preferred embodiments of the invention. The foregoing has outlined some of the more pertinent objects of the invention. These objects should be construed to be merely illustrative of some of the more prominent features and applications of the present invention. Many other beneficial results can be attained by applying the disclosed invention in a different manner or by modifying the invention within the scope of the disclosure. Accordingly, other objects and a fuller understanding of the invention may be had by referring to the summary of the invention and the detailed description of the preferred embodiments in addition to the scope of the invention illustrated by the accompanying drawings.

### BRIEF DESCRIPTION OF THE DRAWINGS

The foregoing and other objects, features and advantages of the invention will become more fully understood from the following description of the preferred embodiments of the invention as illustrated in the accompanying drawings in which like reference characters refer to the same parts throughout different views.

FIG. 1 is a block diagram showing typical functionality and decision logic of one version of the present invention.

### DETAILED DESCRIPTION OF THE INVENTION

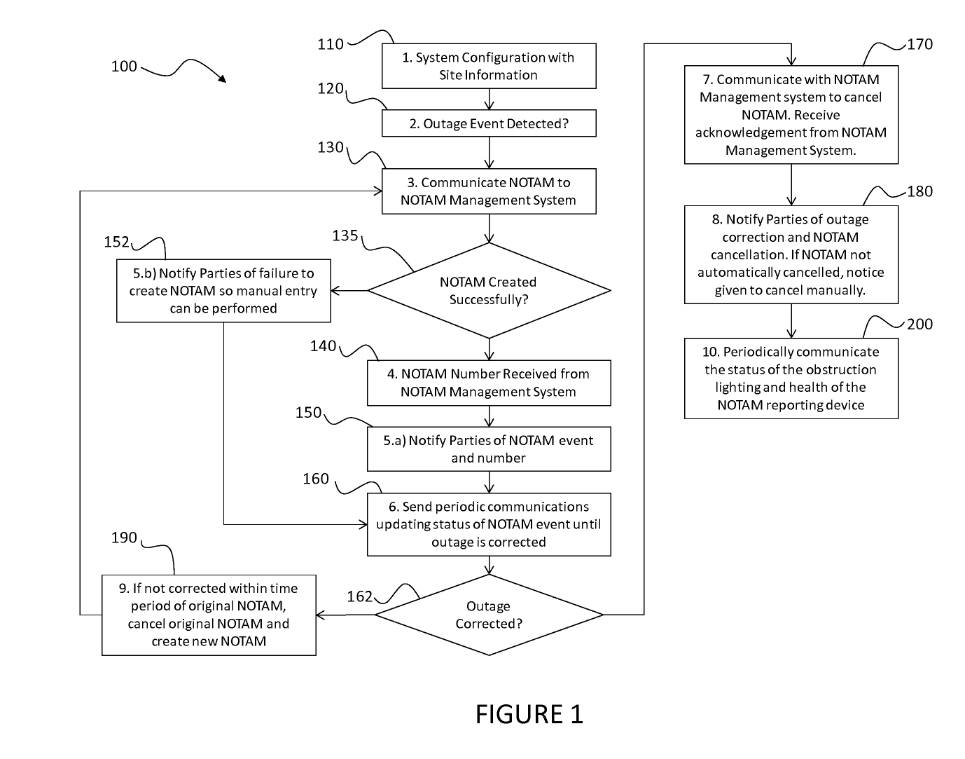

Referring now to the drawings and in particular to FIG. 1, wherein there is illustrated a block diagram of typical functionality and decision logic of one version of the present invention 100, a detailed description of the various functionality and decision logic is provided herein.

Shown in FIG. 1 is one implementation of the present invention. The setup function 110 allows for the device to be configured with information pertaining to the site, lighting devices and information necessary to communicate with external devices and the regulated reporting management system, such as the federal NOTAM management system as currently implemented in the United States. Such setup information will include but is not limited to security information (user ID, password, etc), antenna site registration (ASR) number and parameters necessary to identify the location and type of outage. By entering this information into the system once and verifying the correctness, the potential errors associated with manual entry of this information on a case-by-case reporting event are eliminated.

When an outage event is indicated by an obstruction lighting status condition input 120, a notification action is initiated. The device nominally receives external stimulus from either an electronic obstruction lighting monitoring and/or control device, but the ability to initiate a notification from the manual request of a human operator is also provided to signal an obstruction lighting outage. Inputs and outputs are routed through a communication port on the device.

Upon initiation of notification said device will communicate with the federal NOTAM management system 130 to create a NOTAM for the obstruction lighting outage. An assessment of whether or not the NOTAM was successfully created is made 135.

If the NOTAM is not created successfully, the device will notify the designated parties of the failure to create the NOTAM 152 so that the NOTAM can be created manually. The device then proceeds to monitor and manage the NOTAM 160.

If the NOTAM is created successfully, the device will receive the NOTAM number from the federal NOTAM management system 140.

The device then notifies the appropriate parties 150 via a preferred communication method (such as by email) as well as through an optional local display of the outage. The parties will also be sent a) the NOTAM number or b) alternately the notification that the device was unable to create a NOTAM automatically so that the notified party can create an the NOTAM manually if needed.

The device will send periodic communications 160, such as by email reminders, regarding the lighting outage until the outage is corrected and acknowledged via a local input, web browser interface or communications with the device.

The status of the lighting outage will be monitored 162. When the failure is corrected and the device has been notified of the correction via one of the input methods provided for the purpose of doing so, the device will communicate electronically with the federal NOTAM management system to cancel the NOTAM which was previously created 170. The device will receive an acknowledgment that the NOTAM was canceled from the federal system upon successful cancellation 170.

The device will notify the appropriate party via email, for example, and through an optional local display, of the repair of the outage and subsequent NOTAM cancellation along with the acknowledgment received from the federal system 180. If the device is unable to automatically cancel the NOTAM the appropriate party will be sent notification that the NOTAM must be cancelled manually 180.

If an obstruction lighting outage is not corrected and acknowledged within the time period upon which a NOTAM will expire the device will automatically create a new NOTAM and cancel the previously created NOTAM 190. Information regarding the uncorrected outage, cancelled NOTAM and newly created NOTAM will be communicated to the appropriate party or parties by a standard communication method 130, such as by email or text.

During regular operation, the device will periodically communicate, such as by email to one or more email addresses, information pertaining to the status of the obstruction lighting, the health of the device and its ability to communicate with the federal NOTAM management system and other devices 200.

Certain forms of communication have been indicated in this invention description and are meant to be illustrative of the functionality of the device. It should be understood that preferred and efficient forms of communication are constantly changing, and the functionality of the present invention can be adapted to any current and future modes of communication without loss of generality. For instance, email is used herein as a typical method of communicating system information, but the communication may in fact be accomplished by any number of means.

While this version of the invention has been illustrated and described in detail in the drawings and foregoing description, the same is to be considered as illustrative and not restrictive in character, it being understood that only the preferred embodiments have been shown and described and that all changes and modifications that come within the spirit of the version of the invention are desired to be protected.

From the foregoing, it will be understood by persons skilled in the art that an improved method of automatically reporting NOTAMs has been provided.

Although this invention has been described in its preferred form with a certain degree of particularity, it is understood that the present disclosure of the preferred form has been made only by way of example and numerous changes in the details of communication protocols, construction and combination and arrangement of parts may be resorted to without departing from the spirit and scope of the invention.

What is claimed as the invention is:

1. An automated reporting system for obstruction lighting outages comprising:
a central processing unit, an obstruction lighting status condition input, a communications port, and an output message;
where the status condition input provides the status of the obstruction lighting system;
where the communication port provides an interface to a managed reporting system; and
where the central processing unit transmits the output message to the managed reporting system via the communication port when the status condition input indicates a failure condition.

2. The automated reporting system for obstruction lighting outages according to claim 1, where the output message results in the creation of a notice to airmen (NOTAM) in the managed reporting system,
where the managed reporting system provides a NOTAM number to the automated reporting system, and
where the automated reporting system cancels the NOTAM when the status condition input indicates the failure condition has been corrected.
